(19) United States
(12) Patent Application Publication
(10) Pub. No.: US 2014/0243037 A1
(43) Pub. Date: Aug. 28, 2014

(54) TRANSMITTING POWER OPTIMIZATION ON A WIRELESS COMMUNICATION DEVICE

(71) Applicant: QUALCOMM INCORPORATED, San Diego, CA (US)

(72) Inventors: Divaydeep SIKRI, Farnborough (GB); Abeezar A. Burhan, Ickenham (GB); Mungal S. Dhanda, Slough (GB); Nita E. Joseph, Farnborough (GB)

(73) Assignee: Qualcomm Incorporated, San Diego, CA (US)

(21) Appl. No.: 13/777,113

(22) Filed: Feb. 26, 2013

(51) Int. Cl. H04W 52/04

(52) U.S. Cl. CPC H04W 52/04
USPC 455/522

(57) ABSTRACT

Devices, systems, articles of manufacture, and methods scheduling subscription procedures on a wireless communication device are described. According to some embodiments, a channel condition metric is obtained by the wireless communication device. The wireless communication device determines a number of uplink bursts to be transmitted at a non-reduced transmit power level based on the channel condition metric. The determined number uplink bursts are transmitted at the non-reduced transmit power level. Other aspects, embodiments, and features are also claimed and described.

### TECHNICAL FIELD

The technology discussed below relates generally to communication systems, and more specifically, to systems and methods for transmitting power optimization on a wireless communication device.

### BACKGROUND

Wireless communication systems have become an important means by which many people worldwide have come to communicate. A wireless communication system may provide communication for a number of subscriber stations, each of which may be serviced by a base station. Mobile devices may receive and transmit information to a base station. Transmitting information to a base station may consume large amounts of power on a mobile device, which may reduce battery life. Benefits may be realized by improving how mobile devices transmit data.

### SUMMARY OF SOME EXAMPLE EMBODIMENTS

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A method for communication on a wireless communication device is described. A channel condition metric is obtained. A number of uplink bursts to be transmitted at a non-reduced transmit power level is determined based on the channel condition metric. The determined number of uplink bursts are transmitted at the non-reduced transmit power level.

Power to a transmitter may be reduced when not transmitting the determined number of uplink bursts. Obtaining the channel condition metric may include receiving a downlink burst and measuring one of a receive signal power and a signal-to-noise ratio of the downlink burst. The channel condition metric may be based on an error rate. The uplink bursts may be transmitted using one of a coding scheme and a modulation and coding scheme based on the channel condition metric. The coding scheme and the modulation and coding scheme coding scheme may be determined by a lookup table.

A bit error probability indicator may be received. The channel condition metric may be based on the bit error probability indicator. If the bit error probability indicator is above a threshold, the determined number of uplink bursts are coded with a high efficiency coding scheme. An uplink report may be received. The channel condition metric may be based on the uplink report.

A transmission scheme may be determined. The transmission scheme may vary which uplink burst slots the determined uplink bursts are transmitted on. The transmission scheme may include blanking uplink burst slots in a single radio block that are not transmitted at the non-reduced transmit power level. The transmission scheme may be based on a battery state of charge. The number of uplink bursts transmitted at the non-reduced transmit power level may be less than four. The uplink bursts may be part of a single radio block.

An apparatus for communication on a wireless communication device is also described. The apparatus includes a processor, memory in electronic communication with the processor and instructions stored in the memory. The instructions are executable by the processor to obtain a channel condition metric. The instructions are also executable by the processor to determine a number of uplink bursts to be transmitted at a non-reduced transmit power level based on the channel condition metric. The instructions are further executable by the processor to transmit the determined number of uplink bursts at the non-reduced transmit power level.

A computer-program product for communication on a wireless communication device is described. The computer-program product includes a non-transitory computer-readable medium having instructions thereon. The instructions include code for causing the wireless communication device to obtain a channel condition metric. The instructions also include code for causing the wireless communication device to determine a number of uplink bursts to be transmitted at a non-reduced transmit power level based on the channel condition metric. The instructions further include code for causing the wireless communication device to transmit the determined number of uplink bursts at the non-reduced transmit power level.

An apparatus configured for communication on a wireless communication device is also described. The apparatus includes means for obtaining a channel condition metric. The apparatus also includes means for determining a number of uplink bursts to be transmitted at a non-reduced transmit power level based on the channel condition metric. The apparatus further includes means for transmitting the determined number of uplink bursts at the non-reduced transmit power level.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 shows an example of a wireless communication system in which the systems and methods disclosed herein may be utilized;

FIG. 2 is a block diagram illustrating a wireless communication device and a base station in a wireless communication system according to some embodiments;

FIG. 3 is a flow diagram of a method for scheduling/transmitting uplink bursts according to some embodiments;

FIG. 4 is a block diagram illustrating uplink burst transmission options based on a channel condition metric according to some embodiments;

FIG. 5 is a flow diagram of a more detailed method for scheduling/transmitting uplink bursts according to some embodiments;

FIG. 6 shows another example of a wireless communication system in accordance with some embodiments;

FIG. 7 shows a block diagram of a transmitter and a receiver in a wireless communication system according to some embodiments; and

FIG. 8 illustrates certain components that may be included within a wireless communication device according to some embodiments.

### DETAILED DESCRIPTION

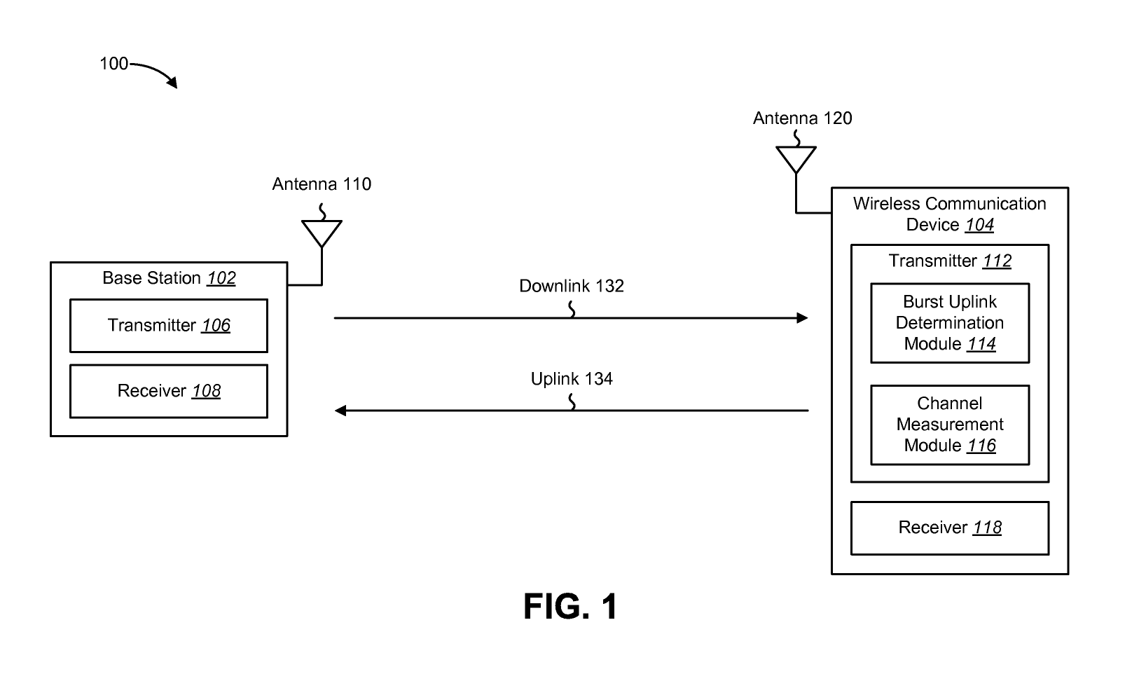

FIG. 1 shows an example of a wireless communication system 100 in which the systems and methods disclosed herein may be utilized. The wireless communication system 100 may include a base station 102 and a wireless communication device 104. According to the system and methods of the present invention, the wireless communication device 104 may transmit information to the base station 102 more efficiently. For example, the wireless communication device 104 may conserve power by transmitting data in fewer uplink bursts in an uplink radio block or by reducing transmit power levels during the transmission of an uplink radio block.

The wireless communication system 100 may be a GSM (global system for mobile communications) network that employs general packet radio service (GPRS), enhanced GPRS (EGPRS) and enhanced GPRS phase 2 (EGPRS2). EGPRS is also referred to as enhanced data rates for GSM evolution) (EDGE). EGPRS2 is also referred to as Evolved GERAN. Accordingly, the wireless communication system 100 may be a GSM/EDGE radio access network (GERAN).

As used herein, the term “wireless communication device” refers to an electronic device that may be used for voice and/or data communication over a wireless communication system. Examples of wireless communication devices 104 may include access terminals, client devices, client stations, etc., and may wirelessly communicate with other communication devices (e.g., base stations 102 and wireless communication devices 104). Some wireless communication devices 104 may be referred to as stations (STAB), mobile devices, mobile stations, subscriber stations, user equipments (UEs), remote stations, access terminals, mobile terminals, terminals, user terminals, subscriber units, etc. Additional examples of wireless communication devices 104 include laptop or desktop computers, cellular phones, smart phones, wireless modems, e-readers, tablet devices, gaming systems, etc.

The term “base station” refers to a wireless communication station that is used to communicate with wireless communication devices 104. A base station 102 may alternatively be referred to as an access point (including nano-, pico- and femto-cells), a Node B, an evolved Node B (eNodeB), a Home Node B, or some other similar terminology.

The wireless communication device 104 may communicate with the base station 102 on a downlink 132 and/or an uplink 134. The downlink 132, or forward link, refers to the communication link from the base station 102 to the wireless communication device 104. The uplink 134, or reverse link, refers to the communication link from the wireless communication device 104 to the base station 102. As used herein, the terms uplink 134 and downlink 132, in some instances, may refer to the communication link or to the carriers used for the communication link. For example, an uplink radio block of data may be transmitted on the uplink 134.

The base station 102 may include a transmitter 106, a receiver 108, and an antenna 110. The transmitter 106 may send data, such as voice data, user data, and/or control data, and other signals from the base station 102 to the wireless communication device 104. The receiver 118 may receive data from the wireless communication device 104. For example, the base station 102 may transmit downlink radio blocks to the wireless communication device 104 and receive uplink radio blocks from the wireless communication device 104.

The wireless communication device 104 may include a transmitter 112, a receiver 118, and an antenna 120. The transmitter 112 may include a burst uplink determination module 114 and a channel measurement module 116. The transmitter 112 may send communications to the base station 102 via the antenna 120.

The channel measurement module 116 may obtain information regarding the channel condition and quality. For example, the channel measurement module 116 may receive information regarding channel conditions from the base station 102 or from other devices on the wireless communication system 100.

The channel measurement module 116 may also obtain channel conditions by performing channel measurements at the wireless communication device 104. For example, the channel measurement module 116 may obtain channel conditions by performing channel measurements on the downlink 132 at the wireless communication device 104 and/or by deducing uplink channel conditions. The channel measurement module 116 may also use the uplink transmit power and/or the timing advance commanded by the network.

The channel condition measurement may be stored as a channel condition metric. The channel condition metric may indicate if a channel is clear or if the channel includes noise and/or interference. For instance, the channel condition metric may indicate the amount of noise and interference in a channel.

The burst uplink determination module 114 may prepare and transmit an uplink radio block via the uplink 134. The uplink radio block may include data, such as voice data, user data, and/or control data, to be sent to the base station 102. The burst uplink determination module 114 may also determine, based on channel conditions, the number of uplink bursts required to send to the base station 102. In this manner, the wireless communication device 104 may conserve power when transmitting radio blocks to the base station 102. Thus, battery life may be extended on the wireless communication device 104.

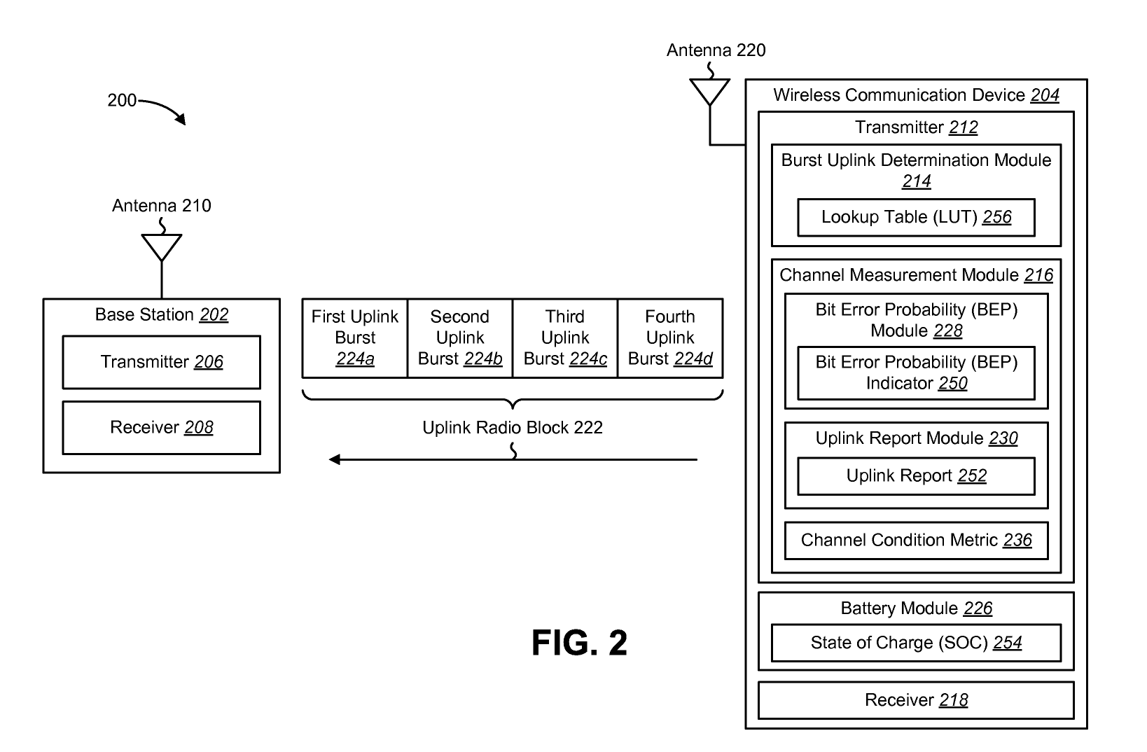

In some configurations, the burst uplink determination module 114 may further determine which coding scheme and transmission to use based on channel conditions. Coding schemes and transmission schemes are described below in FIG. 2.

FIG. 2 is a block diagram illustrating a wireless communication device 204 and a base station 202 in a wireless communication system 200 according to some embodiments of the present invention. The wireless communication system 200 may be one example of the wireless communication system 100 described in connection with FIG. 1. For example, the wireless communication device 204 may be one example of the wireless communication device 104 described in connection with FIG. 1.

The base station 202 may include a transmitter 206, a receiver 208, and an antenna 210. The transmitter 206 may send data, such as voice data, user data, and/or control data, and other signals from the base station 202 to the wireless communication device 204. The receiver 208 may receive data from the wireless communication device 204.

The wireless communication device 204 may include a transmitter 212, a receiver 218, a battery module 226, and an antenna 220. The battery module 226 may monitor the state of charge (SOC) 254 of a battery on the wireless communication device 104. For example, if the battery on the wireless communication device 204 is nearly full, the state of charge (SOC) 254 may indicate a nearly full battery.

The state of charge (SOC) 254 may be used by the wireless communication device 204 in determining when power conserving measures should be taken and when power saving measures are less critical. For instance, the state of charge (SOC) 254 may indicate that a wireless communication device 204 is currently connected to a power source, such as an alternating current (AC) charger. In this instance, the state of charge (SOC) 254 may indicate that power saving measures are less critical. As another example, the state of charge (SOC) 254 may indicate that there is a low battery and that battery saving measures should be employed.

The transmitter 212 may send communications to the base station 202 via the antenna 120. For example, the transmitter 212 may transmit one or more uplink radio blocks 222 to the base station 202 via the uplink 134. The receiver 218 may receive data from the base station 202, such as downlink radio blocks (not shown) via the downlink 132. The transmitter 212 may include a burst uplink determination module 214 and a channel measurement module 216.

The channel measurement module 216 may include a bit error probability (BEP) module 228, an uplink report module 230, and a channel condition metric 236. The channel measurement module 216 may obtain information regarding the channel condition and quality from the bit error probability (BEP) module 228 and the uplink report module 230. For example, the bit error probability (BEP) module 228 may receive a bit error probability (BEP) indicator 250 on the downlink 132.

The bit error probability (BEP) indicator 250 may indicate the channel quality in varying channel conditions. In some configurations, the bit error probability (BEP) indicator 250 may include measurements such as mean bit error probability (BEP) and CV bit error probability (BEP). Mean bit error probability (BEP) may refer to the average mean bit error probability (BEP) during a reporting period, such as a radio block. CV bit error probability (BEP) may refer to the average coefficient of variation during the reporting period, where CV is calculated by dividing the standard deviation of bit error probability (BEP) over the mean bit error probability (BEP) within a radio block. Accordingly, the bit error probability (BEP) module 228 may indicate channel conditions on the downlink 132, which may then be used by the channel measurement module 216 to calculate channel conditions on the uplink 134.

The uplink report module 230 may obtain uplink reports 252 indicating the channel quality of the uplink 134. For example, the uplink report module 230 may receive an uplink ACK (acknowledgement) or NACK (negative acknowledgement) report. The uplink report module 230 may use the ACK and/or NACK report to determine channel conditions and channel quality on the uplink 134. In some configurations, the channel measurement module 216 may determine the channel condition metric 236 based on the bit error probability (BEP) indicator 250 and the uplink report 252.

The channel measurement module 216 may also obtain channel conditions by performing channel measurements at the wireless communication device 204. For example, the channel measurement module 216 may perform measurements on data received by the wireless communication device 204. For instance, the receiver 218 on the wireless communication device 204 may receive downlink radio blocks (not shown) from the base station 202. The downlink radio blocks may include downlink bursts. The channel measurement module 216 may measure the power levels and/or the signal-to-noise ratio (SNR) using the downlink bursts. As an example, the channel measurement module 216 may perform measurements on a received bit error probability (BEP) indicator 250 or uplink report 252 to determine channel conditions on the uplink 134.

The channel condition measurement may be stored as a channel condition metric 236. The channel condition metric 236 may indicate if a channel is clear or if the channel includes noise and/or interference. For instance, the channel condition metric 236 may indicate the quality of the uplink 134, the amount of noise in the channel, and/or the interference in the channel.

The burst uplink determination module 214 may prepare and transmit an uplink radio block 222 via the uplink 134. For example, the uplink radio block 222 may send data in a first uplink burst 224a, a second uplink burst 224b, a third uplink burst 224c, and/or a fourth uplink burst 224d. The burst uplink determination module 214 may determine that only a partial uplink radio block 222 is required to send data to the base station 202. A partial uplink radio block 222 is a radio block that does not transmit all the uplink bursts 224 at normal (i.e., non-reduced) transmit power levels. Additional detail is given below regarding partial uplink radio blocks 222.

The burst uplink determination module 214 may determine, based on channel conditions, the number of uplink bursts 224 needed or the manner (e.g., transmission scheme) in which to send the uplink bursts 224 to the base station 202. The burst uplink determination module 214 may operate based on the channel condition metric 236 and other measurements obtained by the wireless communication device 204.

The burst uplink determination module 214 may operate without the assistance of the base station 202 or other devices in the wireless communication system 200. Additional detail regarding determining the number of uplink bursts 224 to send and the manner of transmitting the uplink radio block 222 is described below.

The uplink bursts 224 may be coded according to a coding and/or modulation scheme. Coding schemes (CS), and modulation and coding schemes (MCS) may be used in wireless communication systems 200 employing GPRS and EGPRS. For example, the base station 202 and the wireless communication device 204 may use GPRS coding schemes and EGPRS coding schemes on downlink bursts, and uplink bursts 224, respectively, before transmitting the radio blocks. In GPRS, coding schemes such as CS-1, CS-2, CS-3 and CS-4 may be used on uplink bursts 224. In general, control messages are sent using CS-1 messaging on an uplink control channel. In EGPRS, modulation & coding schemes such as MCS-1, MCS-2, MCS-3, MCS-4, MCS-5, MCS-6, MCS-7, MCS-8 and MCS-9 may be used on the uplink bursts 224. Using coding schemes allows data rates and throughput to be increased based on signal conditions.

Coding schemes, such as CS-1 and MCS-1, may include larger amounts of error correction data and may be designed for poor channel conditions while coding schemes, such as CS-2 and MCS-2, may include smaller amounts of error correction data and may be better suited for clearer channel conditions. In other words, CS-1 and MCS-1 may include more error correction data per uplink burst 224 than CS-2 and MCS-2, respectively. More error correction data may assist in decoding received data correctly. This is particularly useful in the case of a poor or unclear channel where parts of transmitted data may be lost or corrupted.

Coding schemes with a higher corresponding number may have a higher efficiency in transporting data than coding schemes with a lower corresponding number. For example, MCS-1 may transmit at a rate of 8.8 kilobits per second (kbps), MCS-2 may transmit at a rate of 21.2 kbps, MCS-5 may transmit at a rate of 22.4 kbps, and MCS-6 may transmit at a rate of 29.6 kbps. Thus, MCS-6 may transmit at a higher efficiency than MCS-1, MCS-2, and MCS-5. In a similar manner, CS-2 may be a higher efficiency coding scheme than CS-1. This higher efficiency occurs because the uplink bursts 224 include a set amount of time for data to be transmitted. Thus, uplink bursts 224 that include smaller amounts of error correction data may include larger amounts of data (e.g., voice data, user data, control data, etc.) and thus have a higher efficiency.

Furthermore, coding schemes (CS), and modulation and coding schemes (MCS) may allow for early decoding on the packet data traffic channel (PDTCH) and on control channels. For example, for data received on the PDTCH encoded with MCS-1, MCS-2, MCS-5, and MCS-6, a downlink radio block may be decoded at the wireless communication device 204 in two or three downlink bursts, rather than four downlink bursts, under good/moderate channel conditions. For instance, if the current downlink coding scheme is MCS-9 under normal signal conditions, then a single Transmission Control Protocol (TCP) ACK/NACK may be sent via MCS-6 under good signal conditions in a non-congested network.

The burst uplink determination module 214 may determine which coding scheme to use based on channel conditions. For example, the burst uplink determination module 214 may determine which coding scheme to use based on the channel condition metric 236 received/obtained by the channel measurement module 216. In some configurations, the burst uplink determination module 214 may employ a lookup table (LUT) 256 to determine which coding scheme to use based on channel conditions.

Each uplink burst 224 may be coded based on current channel conditions. For instance, the wireless communication device 204 may code each uplink burst 224 based on the current channel conditions and channel quality as indicated by the channel condition metric 236. Thus, as the channel conditions improve and become clearer, the burst uplink determination module 214 may select higher efficiency coding schemes that allocate more space to data and less space to error correction data.

In some configurations, the wireless communication device 204 transmits four uplink bursts 224a-d in the uplink radio block 222. For example, the wireless communication device 204 sends the first uplink burst 224a, the second uplink burst 224b, the third uplink burst 224c, and the fourth uplink burst 224d in the uplink radio block 222. The base station 202 receives the four uplink bursts 224a-d and decodes the data from the wireless communication device 204. If the base station 202 fails to decode the data block, the base station 202 may request retransmission of the four uplink bursts 224a-d. Thus, in this configuration, the wireless communication device 204 transmits four uplink bursts 224a-d in the uplink radio block 222 to the base station 202 in every uplink radio block 222.

Even if channel conditions are clear and the same amount of data could be sent in fewer bursts with a higher efficiency coding scheme (e.g., less error correction data and more data per uplink burst 224), the wireless communication device 204 still transmits four uplink bursts 224a-d. For each uplink burst 224 transmitted, the transmitter 212 must remain powered on. If the same amount of data could be sent in fewer uplink data bursts 224 per uplink radio block 222, transmitting four uplink bursts 224a-d causes the wireless communication device 204 to remain powered on for longer or to transmit at a higher power level than necessary. Accordingly, this shortens battery life unnecessarily and degrades performance.

Furthermore, transmitting data by the wireless communication device 204 consumes a large amount of power on the wireless communication device 204 compared to receiving data or performing other functions. Thus, reducing the time spent transmitting by the wireless communication device 204 may result in a large amount of savings to battery life on the wireless communication device 204.

In one configuration according to the present invention, the wireless communication device 204 may transmit a partial uplink radio block 222 (i.e., fewer than four uplink bursts 224). For example, the wireless communication device 204 may transmit two uplink bursts 224a-b or three uplink bursts 224a-c when channel conditions are clear.

The burst uplink determination module 214 may use the channel condition metric 236 to determine that, based on channel conditions being clear, only the first uplink burst 224a and the second uplink burst 224b need to be transmitted to the base station 202. By transmitting fewer uplink bursts 224, the wireless communication device 204 may power off or reduce power to the transmitter 212 earlier. Thus, when channel conditions are clear, the wireless communication device 204 may conserve additional battery life by transmitting fewer uplink bursts 224 in each uplink radio block 222.

In addition, when channel conditions are clear, the burst uplink determination module 214 may select a higher efficiency coding scheme. Accordingly, the wireless communication device 204 may be able to transmit the same amount of data (e.g., voice data, user data, control data, etc.) using fewer uplink bursts 224. As an example, if the channel condition metric 236 is based on a bit error probability (BEP) indicator 250, the bit error probability (BEP) indicator 250 may be compared to one or more thresholds to determine which coding scheme to employ. For instance, if a bit error probability (BEP) indicator 250 is above Threshold_x, then channel conditions may permit a partial uplink radio block 222 to be transmitted (coded with CS-1). Similarly, if the bit error probability (BEP) indicator 250 is above Threshold_y, then conditions may permit a partial uplink radio block 222 to be transmitted (coded with CS-1, MCS-5 or MSC-6).

If the base station 202 receives the necessary data from the wireless communication device 204 in fewer than four uplink bursts 224 in an uplink radio block 222, the base station 202 may not request data to be retransmitted. The base station 202 may be satisfied with receiving fewer than four uplink bursts 224 in a partial uplink radio block 222 from the wireless communication device 204 if the partial uplink radio block 222 includes the same amount of data as a full uplink radio block 222 with four uplink bursts 224.

In some instances, the base station 202 may not decode control information link radio link control (RLC) ACKs or NACKs unless a full uplink radio block 222 is received. In this case, the base station 202 may request retransmission, which may cause throughput to degrade. If the base station 202 requires a full uplink radio block 222, the wireless communication device 204 may reduce power to uplink bursts 224 that are not needed. For example, if the channel condition metric 236 indicates that two uplink bursts 224 are needed, the wireless communication device 204 may transmit data in the first uplink burst 224a and the second uplink burst 224b at full transmission power levels and transmit redundant data on the third uplink burst 224c and the fourth uplink burst 224d at reduced transmit power levels (e.g., at 5 dB or 10 dB less power). In this manner, power on the wireless communication device 204 may be conserved. Further, transmitting redundant data in the latter uplink bursts 224 provides backup data for the base station 202 in case data in the first uplink bursts 224 is not properly decoded.

The amount of reduction to the transmit power may depend on channel conditions. For example, a large transmit power reduction may be warranted under clear channel conditions and/or when the network is not congested. A smaller transmit power reduction may be warranted under moderate channel conditions. In some cases, reducing a large amount of transmit power may have the equivalent effect as not transmitting the uplink burst 224.

If the transmit power is reduced, all the uplink bursts 224 may still be transmitted to the base station, even if not all the uplink bursts 224 are transmitted at normal (i.e., non-reduced) power. In this manner, the base station 202 receives all four uplink bursts 224 while the wireless communication device 204 conserves power. This prevents the need for the wireless communication device 204 to retransmit data, which degrades throughput. For example, when employing MSC-1, MSC-2, MSC-5, or MSC-6, sending a partial uplink radio block 222 may cause the wireless communication system 200 to perform a link adaption, which may cause throughput to suffer. Thus, by reducing the amount of transmit power instead of transmitting a partial uplink radio block 222, the wireless communication device 204 may conserve power and avoid a link adaptation.

If the base station 202 accepts a partial uplink radio block 222 (and the channel condition metric 236 warrants it), the wireless communication device 204 may transmit a partial uplink radio block 222. If less than four uplink bursts 224 are needed, the wireless communication device 204 may determine which uplink bursts 224 to transmit data in. For example, if only two uplink bursts 224 are needed, the wireless communication device 204 may transmit data in the first uplink burst 224a and the fourth uplink burst 224d, the second uplink bursts 224b and third uplink burst 224c, the first uplink burst 224a and third uplink burst 224c, etc. In this example, two uplink bursts 224 may include data and two uplink bursts 224 may be blanked, or void of data.

In some wireless communication systems 200, both the wireless communication device 204 and the base station 202 may employ fewer bursts per radio block when channel conditions are clear. Thus, the wireless communication device 204 may conserve power in both receiving radio blocks from the base station 202 and transmitting uplink radio blocks 222 to the base station 202. In this manner, the wireless communication device 204 may increase battery life.

If the burst uplink determination module 214 determines that fewer than four uplink bursts 224 are required, the wireless communication device 204 may power down or reduce power to the transmitter 212 for the time slot for which no uplink bursts 224 are required to be transmitted. This allows the wireless communication device 204 to conserve power by not having to send extra transmissions/redundant transmissions at normal (i.e., non-reduced) transmit power. In some configurations, it also allows the wireless communication device 204 to conserve power by not performing unnecessary operations, such as selecting a coding scheme to use, coding data, and obtaining a channel condition metric 236. Thus, additional power savings may be achieved by reducing the number of uplink bursts 224 transmitted at normal (i.e., non-reduced) transmit power levels per uplink radio blocks 222.

It should be appreciated that a combination of blanking uplink bursts 224 (i.e., non-transmission of an unnecessary uplink radio block 222) and reducing power to uplink burst 224 transmissions may be employed. Further, the wireless communication device 204 may alternate which uplink radio blocks 222 to perform these operations on. For example, the wireless communication device 204 may perform blanking and/or transmit power reduction on one uplink radio block 222 every “X” number of uplink radio blocks 222, where “X” is a positive integer that is greater than two.

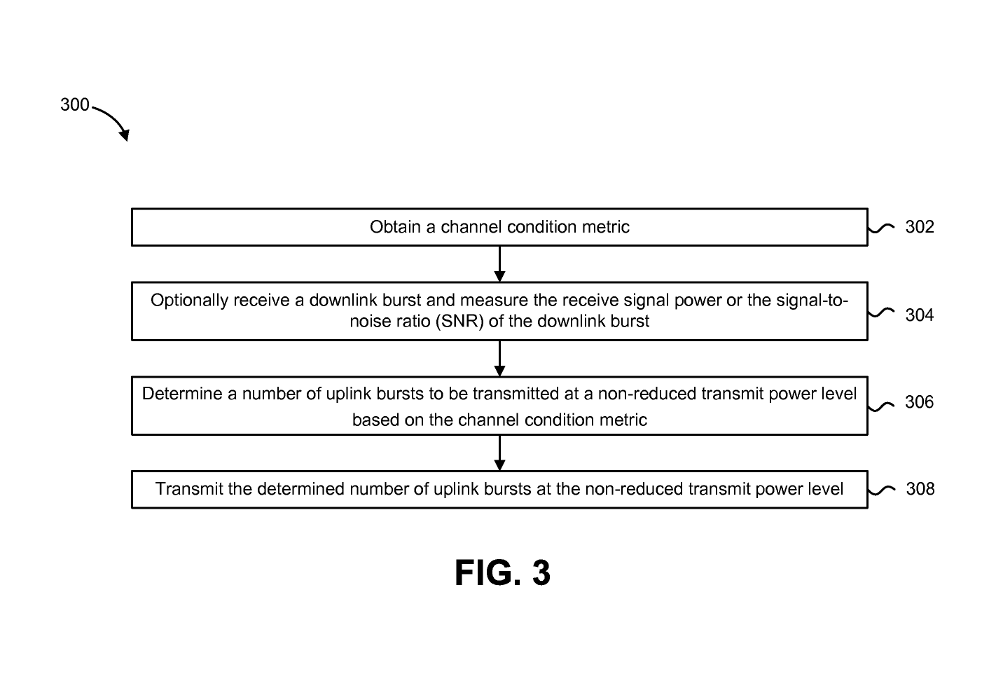

FIG. 3 is a flow diagram of a method 300 for scheduling/transmitting uplink bursts 224 according to some embodiments of the present invention. The method 300 may be performed by a wireless communication device 104. For example, the wireless communication device 104 described in connection with FIG. 1 may perform the method 300.

The wireless communication device 104 may obtain 302 a channel condition metric 236. For example, the channel condition metric 236 may be obtained by the channel measurement module 116. The channel measurement module 116 may receive information regarding channel conditions from the base station 102 and/or by performing channel measurements. For example, the channel measurement module 116 may determine a channel condition metric 236 based on a bit error probability (BEP) indicator 250 and/or an uplink report 252. The channel condition metric 236 may indicate the condition and quality of the uplink channel.

The wireless communication device 104 may optionally receive 304 a downlink burst and measure the receive signal power or the signal-to-noise ratio (SNR) of the downlink burst. Measuring the receive signal power or the signal-to-noise ratio (SNR) of the downlink burst may assist the wireless communication device 104 in obtaining the channel condition metric 236. For example, a channel measurement module 116 on the wireless communication device 104 may obtain the channel condition metric 236 by measuring the power levels and/or the signal-to-noise ratio (SNR) of the downlink bursts received at the wireless communication device 104.

The wireless communication device 104 may determine 306 a number of uplink bursts 224 to be transmitted at a non-reduced transmit power level based on the channel condition metric 236. The burst uplink determination module 114 may determine the minimum number of uplink bursts 224 needed for an uplink radio block 222 to send data to the base station 102. If the uplink is clear, the burst uplink determination module 114 may determine that only two or three uplink bursts 224 per uplink radio block 222 are required to be sent at normal (i.e., non-reduced) transmit power levels. The remaining uplink burst 224 slots in the uplink radio block 222 may be blanked (e.g., includes no data and/or the transmit power is disabled) and/or transmitted at a reduced transmit power level to conserve power.

One way the burst uplink determination module 114 may use fewer uplink bursts 224 is by selecting higher efficiency coding schemes that can transmit the same amount of data in fewer uplink bursts 224 per uplink radio block 222. If the uplink channel is not clear, the burst uplink determination module 114 may determine that all four uplink bursts 224a-d per uplink radio block 222 are required to be sent at normal (i.e., non-reduced) power.

The wireless communication device 104 may transmit 308 the determined number of uplink bursts 224 at the non-reduced transmit power level. In other words, the wireless communication device 104 may transmit the number of uplink bursts 224 determined and prepared by the burst uplink determination module 114 at normal (i.e., non-reduced) power. If fewer than four uplink bursts 224a-d are transmitted per uplink radio block 222, the wireless communication device 104 may power off the transmitter 112 during the remaining uplink burst slots (e.g., uplink burst time slots) where no data is being transmitted and/or reduce the transmit power level during the remaining uplink burst slots.

As an example, if the burst uplink determination module 114 determines that only two uplink bursts 224 are needed per uplink radio block 222, the wireless communication device 104 may transmit data to the base station 102 during the first uplink burst 224a and the third uplink burst 224c of the uplink radio block 222. The wireless communication device 104 may power off the transmitter 112 during the second uplink burst 224b and may reduce the transmit power level by 10 dB during the fourth uplink burst 224d. In this manner, the wireless communication device 104 may conserve power by not performing unnecessary transmissions and/or operations when channel conditions are clear.

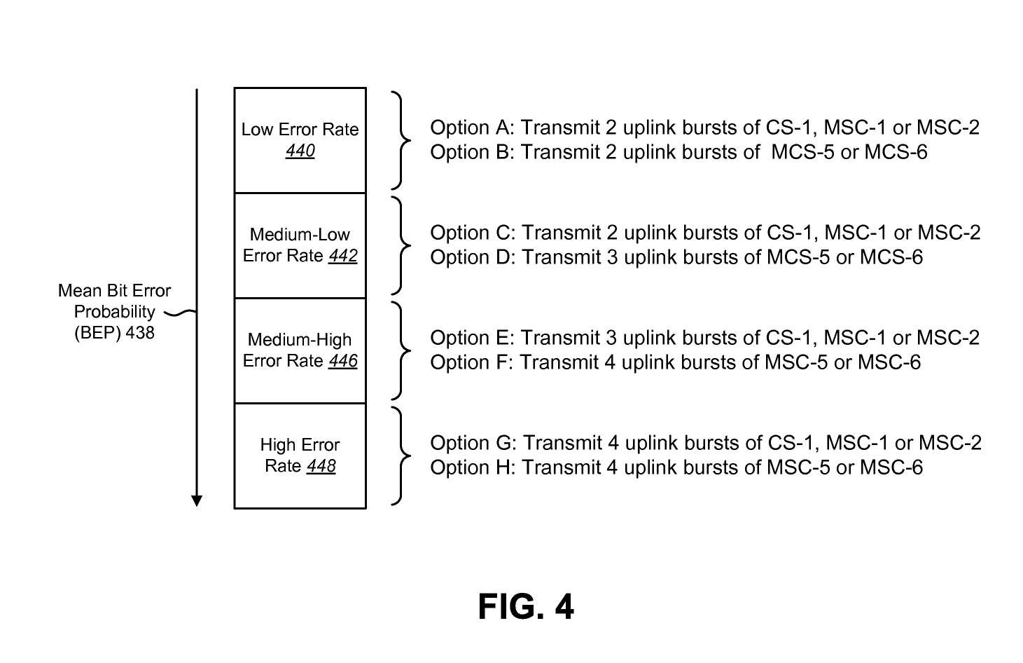

FIG. 4 is a block diagram illustrating uplink burst 224 transmission options based on a channel condition metric 236. A wireless communication device 104 may receive a bit error probability (BEP) indicator 250 that includes a mean bit error probability (BEP) 438. The mean bit error probability (BEP) 438 may indicate the error rate of bits in a channel, such as the downlink 132 or the uplink 134. The wireless communication device 104 may use a bit error probability (BEP) indicator 250 to determine which transmission option to employ based on channel conditions and/or channel quality.

It should be appreciated that the transmission options in FIG. 4 serve as an example and that these options may be extended and/or modified. For example, while FIG. 4 uses mean bit error probability (BEP) 438, other indicators, such as the channel condition metric 236 may be used to determine which transmission options should be employed by the wireless communication device 104. As another example, FIG. 4 may be extended to GPRS networks, for example, using a Gaussian minimum shift keying (GMSK) mean bit error probability (BEP), and may include CS-2 messaging.

The mean bit error probability (BEP) 438 may indicate a low error rate 440, a medium-low error rate 442, a medium high error rate 446, and a high error rate 448. For example, if the uplink radio block 222 included 32 bits, the low error rate 440 may correspond to 27-32 successfully decoded bits per uplink radio block 222. Thus, the mean bit error probability (BEP) may be about 0-5 bits. The medium-low error rate 442 may correspond to 15-26 successfully decoded bits, or 6-17 unsuccessfully decoded bits, per uplink radio block 222. The medium-high error rate 446 may correspond to 10-14 successfully decoded bits, or 18-22 unsuccessfully decoded bits, per uplink radio block 222. The high error rate 448 may correspond to 0-9 successfully decoded bits, or 23-32 unsuccessfully decoded bits, per uplink radio block 222. It should be appreciated that the low error rate 440, the medium-low error rate 442, the medium high error rate 446, and the high error rate 448 may represent different values than those discussed above.

As used in FIG. 4, transmitting a partial uplink radio block 222 may refer to transmitting a determined number of uplink bursts 224 at normal (i.e., non-reduced) transmit power levels, while the remaining uplink bursts 224 are not transmitted or are transmitted at a reduced transmit power level. For example, in option A, two uplink bursts 224 coded with MSC-2 are transmitted. Thus, a partial uplink radio block 222 is transmitted that includes two uplink bursts 224 that are transmitted at normal (i.e., non-reduced) transmit power levels and two uplink bursts 224 that are transmitted with reduced transmit power levels or are not transmitted at all.

If the mean bit error probability (BEP) 438 indicates a low error rate 440, the wireless communication device 104 may employ option A or option B. The low error rate 440 may indicate that channel conditions are clear and/or the network is uncongested. Under option A, the wireless communication device 104 may transmit a partial uplink radio block 222 that includes two uplink bursts 224 coded with CS-1, for example, on an uplink control channel. The wireless communication device 104 also may transmit two uplink burst 224 using MSC-1 or MSC-2.

Under option B, the wireless communication device 104 may transmit a partial uplink radio block 222 of two uplink bursts 224 coded with MSC-5 and/or MSC-6. Thus, because channel conditions are clear and/or the network is uncongested, the wireless communication device 104 may use higher efficiency modulation and coding schemes to send data to a base station 102.

If the mean bit error probability (BEP) 438 indicates a medium-low error rate 442, the wireless communication device 104 may employ option C or option D. Because channel conditions are not optional, the wireless communication device 104 may need to use more uplink bursts 224 to transmit the same amount of data to the base station 102 (as compared to low error rates 440). Under option C, a partial uplink radio block 222 of two uplink bursts 224 coded with CS-1, MSC-1, and/or MSC-2 are transmitted at normal (i.e., non-reduced) transmit power. Under option D, three uplink bursts 224 are needed to send data coded with MSC-5 and/or MSC-6.

If the mean bit error probability (BEP) 438 indicates a medium high error rate 446, the wireless communication device 104 may employ option E or option F. Under option E, a partial uplink radio block 222 is transmitted that includes three uplink bursts 224 coded with CS-1, MSC-1, and/or MSC-2 that are transmitted at normal (i.e., non-reduced) transmit power, for example, on the uplink control channel. Under option F, channel conditions may be poor and may not allow for partial uplink radio blocks 222 to be transmitted using MSC-5 and/or MSC-6. Thus, under option F, all four uplink bursts 224 are needed to send data coded with MSC-5 and/or MSC-6.

If the mean bit error probability (BEP) 438 indicates a high error rate 448, the wireless communication device 104 may employ option G or option H because of noise and/or interference in the channel. Both option G and option H require the wireless communication device 104 to transmit a full uplink radio block 222 because of poor channel conditions and poor channel quality. In other words, when a high error rate 448 is indicated, no partial uplink radio block transmissions may be successfully sent to the base station 202. Thus, under option G, all four uplink bursts 224 are needed to send data coded with CS-1, MSC-1 and/or MSC-2. Likewise, under option H, all four uplink bursts 224 are needed to send data coded with MSC-5 and/or MSC-6.

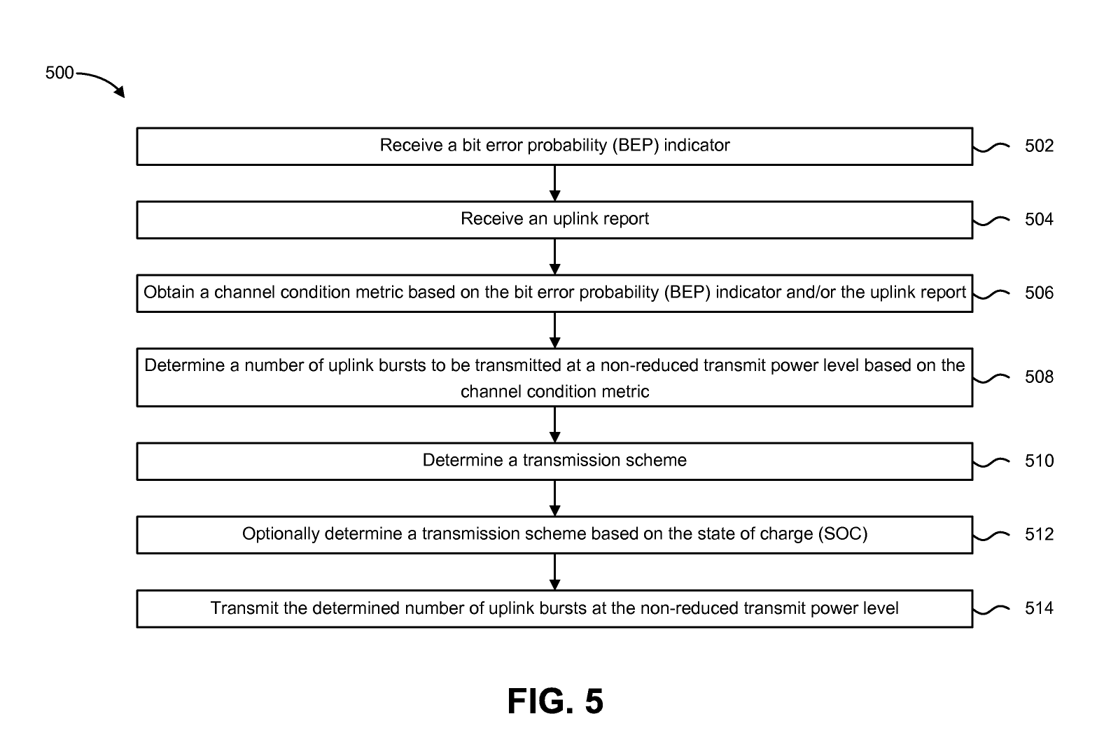

FIG. 5 is a flow diagram of a more detailed method 500 for scheduling/transmitting uplink bursts 224 according to some embodiments of the present invention. The method 500 may be performed by a wireless communication device 104. For example, the wireless communication device 104 described in connection with FIG. 1 may perform the method 500.

The wireless communication device 104 may receive 502 a bit error probability (BEP) indicator 250. The bit error probability (BEP) indicator 250 may be received on the downlink 132. The bit error probability (BEP) indicator 250 may be used to obtain a channel condition metric 236. For example, the bit error probability (BEP) module 228 may process the received bit error probability (BEP) indicator 250. The bit error probability (BEP) indicator 250 may include a mean bit error probability (BEP) and CV bit error probability (BEP), for example. In some configurations, the bit error probability (BEP) indicator 250 may include a mean bit error probability (BEP) similar to the mean bit error probability (BEP) 438 described in connection with FIG. 4.

The wireless communication device 104 may receive 504 an uplink report 252. The uplink report module 230 may process the received uplink report 252. The uplink report 252 may be an ACK or NACK received from a base station 102 in the wireless communication system 100.

The wireless communication device 104 may obtain 506 a channel condition metric 236 based on the bit error probability (BEP) indicator 250 and/or the uplink report 252. The channel condition metric 236 may indicate the condition and quality of the uplink channel. As an example, the channel measurement module 216 may determine that channel conditions are clear based on the channel condition metric 236. This may be because the channel condition metric 236 includes a bit error probability (BEP) indicator 250 that specifies low error rates 440.

The wireless communication device 104 may determine 508 a number of uplink bursts 224 to be transmitted at a non-reduced transmit power level based on the channel condition metric 236. The burst uplink determination module 114 may determine the minimum number of uplink bursts 224 required to send data to the base station 102. If the uplink 134 is clear, the burst uplink determination module 114 may determine that only two or three uplink bursts 224 per uplink radio block 222 are required to be transmitted at normal (i.e., non-reduced) transmit power levels. The determined number of uplink bursts 224 per uplink radio block 222 may also be based on what coding scheme (CS) or modulation and coding scheme (MSC) is employed by the wireless communication device 104. For example, higher efficiency coding schemes may require clearer channel conditions when transmitting partial uplink radio blocks 222.

The wireless communication device 104 may determine 510 a transmission scheme. In one configuration, the wireless communication device 104 may determine 510 a transmission scheme that transmits a partial uplink radio block 222 by transmitting only the determined number of uplink bursts 224 required to send data to the base station 102 and then turning off transmission power for the remaining uplink burst slots that include no data. In another configuration, the wireless communication device 104 may determine 510 a transmission scheme that transmits a partial uplink radio block 222 by transmitting only the determined number of uplink bursts 224 at normal (i.e., non-reduced) transmit power levels while reducing transmit power levels for the remaining uplink bursts 224. In this configuration, the remaining uplink bursts 224 may include redundant data that may be used by the base station 102, if necessary.

In yet another configuration, the wireless communication device 104 may determine 510 a transmission scheme that varies which uplink burst slots transmit the determined number of uplink bursts 224. For example, if only two uplink bursts 224 are needed, the wireless communication device 204 may transmit data in the second uplink bursts 224b and fourth uplink burst 224d at normal (i.e., non-reduced) transmit power level.

The wireless communication device 104 may optionally determine 512 a transmission scheme based on the state of charge (SOC) 254 of the battery. For example, the state of charge (SOC) 254 may indicate that a wireless communication device 204 is currently connected to a power source, such as an alternating current (AC) charger and that uplink radio blocks 222 are to be transmitted at normal (i.e., non-reduced) transmit power levels. As another example, the state of charge (SOC) 254 may indicate to the wireless communication device 204 that there is a low battery and that battery saving measures should be employed.

The wireless communication device 104 may transmit 514 the determined number of uplink bursts 224 at the non-reduced transmit power level. In other words, the wireless communication device 104 may transmit the determined number of uplink bursts 224 at normal (i.e., non-reduced) transmit power levels according to the transmission scheme. For example, the wireless communication device 104 may determine that only two uplink bursts 224 are needed. The wireless communication device 104 may transmit a partial uplink radio block 222 by transmitting data to the base station 102 during the first uplink burst 224a and the third uplink burst 224c of the uplink radio block 222 at normal (i.e., non-reduced) transmit power levels. In this example, the wireless communication device 104 may power off the transmitter 112 during the second uplink burst 224b and may reduce the transmit power level by 5 dB during the fourth uplink burst 224d. In this manner, the wireless communication device 104 may conserve power by not performing unnecessary transmissions and/or operations when channel conditions are clear.

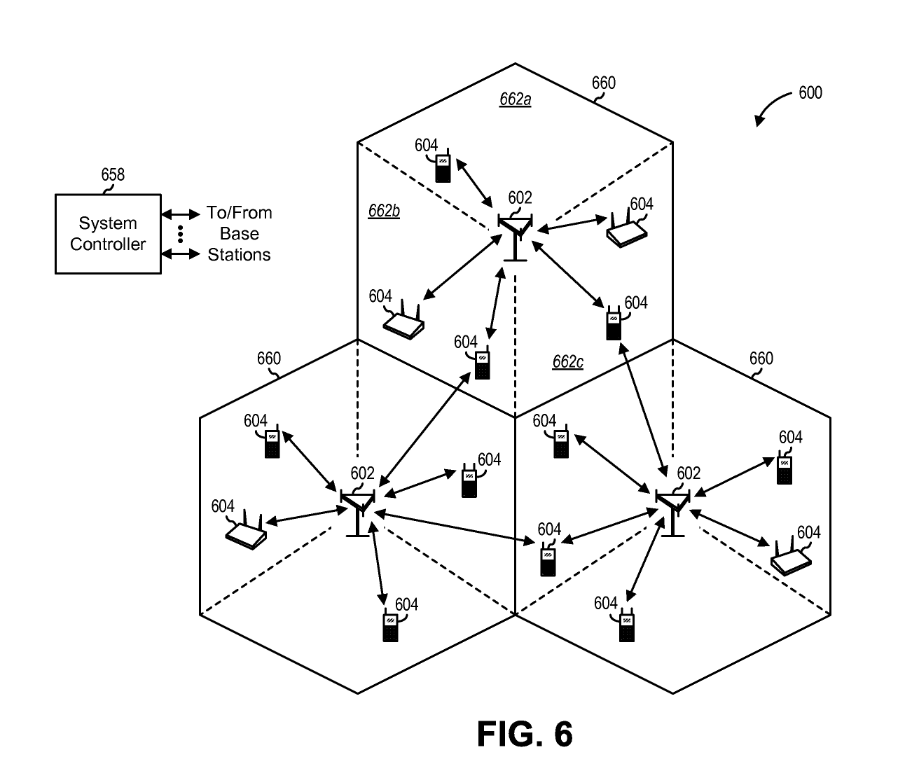

FIG. 6 shows an example of a wireless communication system 600 in which the systems and methods disclosed herein may be utilized. The wireless communication system 600 includes multiple base stations 602 and multiple wireless communication devices 604. Each base station 602 provides communication coverage for a particular geographic area 660. The term “cell” can refer to a base station 602 and/or its coverage area 660, depending on the context in which the term is used.

To improve system capacity, a base station coverage area 660 may be partitioned into plural smaller areas, e.g., three smaller areas 662a, 662b, and 662c. Each smaller area 662a, 662b, 662c may be served by a respective base transceiver station (BTS). The term “sector” can refer to a BTS and/or its coverage area 662, depending on the context in which the term is used. For a sectorized cell, the BTSs for all sectors of that cell are typically co-located within the base station 602 for the cell.

For a centralized architecture, a system controller 658 may couple to the base stations 602 and provide coordination and control for the base stations 602. The system controller 658 may be a single network entity or a collection of network entities. For a distributed architecture, base stations 602 may communicate with one another as needed.

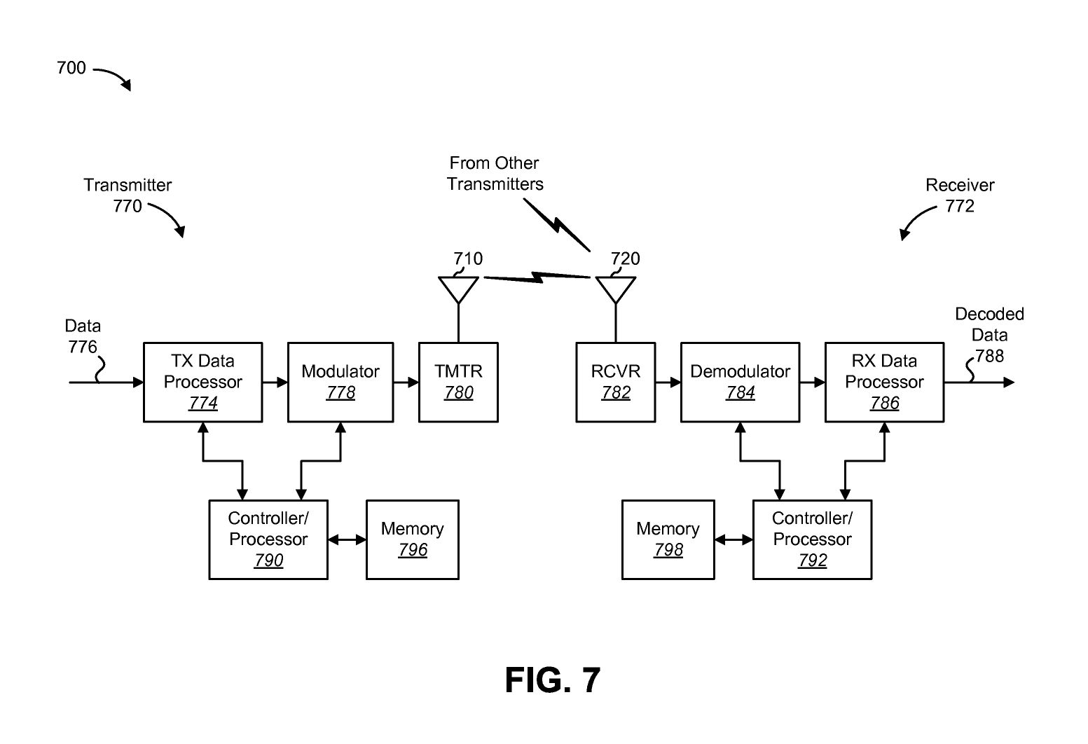

FIG. 7 shows a block diagram of a transmitter 770 and a receiver 772 in a wireless communication system 700. For the downlink, the transmitter 770 may be part of a base station 702 and the receiver 772 may be part of a wireless communication device 704. For the uplink, the transmitter 770 may be part of a wireless communication device 704 and the receiver 772 may be part of a base station 702.

At the transmitter 770, a transmit (TX) data processor 774 receives and processes (e.g., formats, encodes, and interleaves) data 776 and provides coded data. A modulator 778 performs modulation on the coded data and provides a modulated signal. The modulator 778 may perform Gaussian minimum shift keying (GMSK) for GSM, 8-ary phase shift keying (8-PSK) for Enhanced Data rates for Global Evolution (EDGE), etc. GMSK is a continuous phase modulation protocol, whereas 8-PSK is a digital modulation protocol. A transmitter unit (TMTR) 780 conditions (e.g., filters, amplifies, and upconverts) the modulated signal and generates an RF-modulated signal, which is transmitted via an antenna 710.

Other modulations may also be used by mobiles and/or network supporting EGPRS2. For example, QPSK, 16-QAM and 32-QAM modulations may be employed. Mobile station operating in EGPRS2 may use modulation and coding schemes (MCS) UAS-7 (uplink modulation and coding scheme A), UAS-8, UAS-9, UAS-10, UAS-11, UBS-7 (uplink modulation and coding scheme B), UBS-6, UBS-7, UBS-8, UBS-9, UBS-10, UBS-1 land UBS-12. Networks may use DAS-7 (downlink modulation and coding scheme A), DAS-6, DAS-7, DAS-8, DAS-9, DAS-10, DAS-11, DAS-12, DBS-7 (downlink modulation and coding scheme), DBS-6, DBS-7, DBS-7, DBS-8, DBS-9, DBS-10, DBS-11 and DBS-12.

At the receiver 772, an antenna 720 receives RF-modulated signals from the transmitter 770 and other transmitters. The antenna 720 provides a received RF signal to a receiver unit (RCVR) 782. The receiver unit 782 conditions (e.g., filters, amplifies, and downconverts) the received RF signal, digitizes the conditioned signal, and provides samples. A demodulator 784 processes the samples as described below and provides demodulated data. A receive (RX) data processor 786 processes (e.g., deinterleaves and decodes) the demodulated data and provides decoded data 788. In general, the processing by demodulator 784 and RX data processor 786 is complementary to the processing by the modulator 778 and the TX data processor 774, respectively, at the transmitter 770.

Controllers/processors 790 and 792 direct operation at the transmitter 770 and receiver 772, respectively. Memories 796 and 798 store program codes in the form of computer software and data used by the transmitter 770 and receiver 772, respectively.

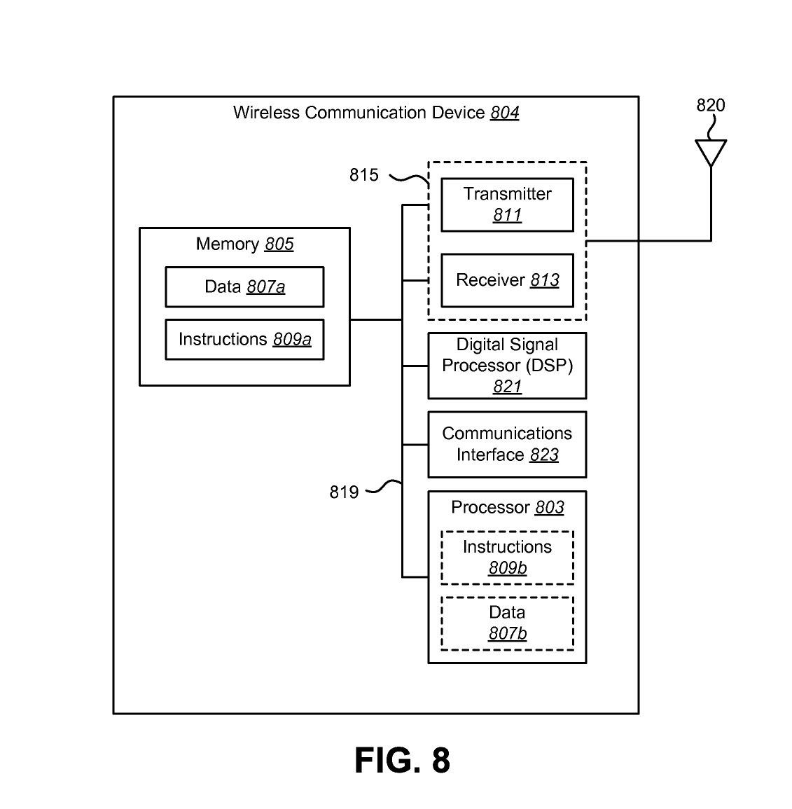

FIG. 8 illustrates certain components that may be included within a wireless communication device 804 according to some embodiments of the present invention. The wireless communication device 804 may be an access terminal, a mobile station, a user equipment (UE), etc. The wireless communication device 804 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the wireless communication device 804 of FIG. 8, in an alternative configuration, a combination of processors (e.g., an ARM and DSP) could be used.

The wireless communication device 804 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The wireless communication device 804 may also include a transmitter 811 and a receiver 813 to allow transmission and reception of signals to and from the wireless communication device 804 via an antenna 820. The transmitter 811 and receiver 813 may be collectively referred to as a transceiver 815. The wireless communication device 804 may also include (not shown) multiple transmitters, multiple antennas, multiple receivers, and/or multiple transceivers.

The wireless communication device 804 may include a digital signal processor (DSP) 821. The wireless communication device 804 may also include a communications interface 823. The communications interface 823 may allow a user to interact with the wireless communication device 804.

The various components of the wireless communication device 804 may be coupled together by one or more buses, which may include a power bus, a control signal bus, a status signal bus, a data bus, etc. For the sake of clarity, the various buses are illustrated in FIG. 8 as a bus system 819.

In the above description, reference numbers have sometimes been used in connection with various terms. Where a term is used in connection with a reference number, this is meant to refer to a specific element that is shown in one or more of the figures. Where a term is used without a reference number, this is meant to refer generally to the term without limitation to any particular figure.

The techniques described herein may be used for various communication systems, including communication systems that employ global system for mobile communications (GSM). GSM is a widespread standard in cellular, wireless communication. GSM is relatively efficient for standard voice services. However, high-fidelity audio and data services require higher data throughput rates than that for which GSM is optimized. To increase capacity, the general packet radio service (GPRS), enhanced GPRS (EGPRS), enhanced GPRS phase 2 (EGPRS2), enhanced data rates for GSM evolution (EDGE) and standards have been adopted in GSM systems. In the GSM/EDGE Radio Access Network (GERAN) specification, GPRS, EGPRS and EGPRS2 provide data services. The standards for GERAN are maintained by the 3GPP (third generation partnership project). GERAN is a part of GSM. More specifically, GERAN is the radio part of GSM/EDGE together with the network that joins the base stations (the Ater and Abis interfaces) and the base station controllers (A interfaces, etc.). GERAN represents the core of a GSM network. It may route phone calls and packet data to and from the public switched telephone network (PSTN) and internet to and from remote terminals.

In some configurations, GERAN may be also a part of combined UMTS/GSM networks. In some configurations, a network can support UMTS only, GSM only or both UMTS and GSM.

GSM employs a combination of Time Division Multiple Access (TDMA) and frequency division multiple access (FDMA) for the purpose of sharing the spectrum resource. GSM networks typically operate in a number of frequency bands. For example, for uplink communication, GSM-900 commonly uses a radio spectrum in the 890-915 megahertz (MHz) bands (mobile station to base transceiver station). For downlink communication, GSM 900 uses 935-960 MHz bands (base station to wireless communication device). Furthermore, each frequency band is divided into 200 kHz carrier frequencies providing 224 radio frequency (RF) channels spaced at 200 kHz. GSM-1900 uses the 1850-1910 MHz bands for the uplink and 1930-1990 MHz bands for the downlink. Like GSM 900, FDMA divides the spectrum for both uplink and downlink into 200 kHz-wide carrier frequencies. Similarly, GSM-850 uses the 824-849 MHz bands for the uplink and 869-894 MHz bands for the downlink, while GSM-1800 uses the 1710-1785 MHz bands for the uplink and 1805-1880 MHz bands for the downlink.

Each channel in GSM is identified by a specific absolute radio frequency channel (ARFCN). For example, ARFCN 1-224 are assigned to the channels of GSM 900, while ARFCN 512-810 are assigned to the channels of GSM 1900. Similarly, ARFCN 128-251 are assigned to the channels of GSM 850, while ARFCN 512-885 are assigned to the channels of GSM 1800.

Furthermore, each wireless communication device may be assigned one or more carrier frequencies (e.g., absolute radio-frequency channel numbers (ARFCNs)). Each carrier frequency is divided into eight time slots using TDMA such that eight consecutive time slots form one TDMA frame with a duration of 4.615 milliseconds (ms). A physical channel occupies one time slot within a TDMA frame. Each active wireless communication device or user is assigned one or more time slot indices for the duration of a call. User-specific data for each wireless communication device is sent in the time slot(s) assigned to that wireless communication device and in TDMA frames used for the traffic channels.

The techniques described herein may also be used for various communication systems, including communication systems that are based on an orthogonal multiplexing scheme. Examples of such communication systems include orthogonal frequency division multiple access (OFDMA) systems, single-carrier frequency division multiple access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that may carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 3 and FIG. 5, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the systems, methods, and apparatus described herein without departing from the scope of the claims.

We claim:

1. A method for communication on a wireless communication device, comprising:
obtaining a channel condition metric;
determining a number of uplink bursts to be transmitted at a non-reduced transmit power level based on the channel condition metric; and
transmitting the determined number of uplink bursts at the non-reduced transmit power level.

2. The method of claim 1, further comprising reducing power to a transmitter when not transmitting the determined number of uplink bursts.

3. The method of claim 1, wherein obtaining the channel condition metric comprises receiving a downlink burst and measuring one of a receive signal power and a signal-to-noise ratio of the downlink burst.

4. The method of claim 1, wherein the channel condition metric is based on an error rate.

5. The method of claim 1, wherein the uplink bursts are transmitted using one of a coding scheme and a modulation and coding scheme based on the channel condition metric.

6. The method of claim 5, wherein the coding scheme and the modulation and coding scheme coding scheme are determined by a lookup table.

7. The method of claim 1, further comprising receiving a bit error probability indicator, wherein the channel condition metric is based on the bit error probability indicator.

8. The method of claim 7, wherein if the bit error probability indicator is above a threshold, the determined number of uplink bursts are coded with a high efficiency coding scheme.

9. The method of claim 1, further comprising receiving an uplink report, wherein the channel condition metric is based on the uplink report.

10. The method of claim 1, further comprising determining a transmission scheme.

11. The method of claim 10, wherein the transmission scheme varies which uplink burst slots the determined uplink bursts are transmitted on.

12. The method of claim 10, wherein the transmission scheme comprises blanking uplink burst slots in a single radio block that are not transmitted at the non-reduced transmit power level.

13. The method of claim 10, wherein the transmission scheme is based on a battery state of charge.

14. The method of claim 1, wherein the number of uplink bursts transmitted at the non-reduced transmit power level is less than four.

15. The method of claim 1, wherein the uplink bursts are part of a single radio block.

16. An apparatus for communication on a wireless communication device, comprising:
a processor;
memory in electronic communication with the processor; and
instructions stored in the memory, the instructions being executable by the processor to:
obtain a channel condition metric;
determine a number of uplink bursts to be transmitted at a non-reduced transmit power level based on the channel condition metric; and
transmit the determined number of uplink bursts at the non-reduced transmit power level.

17. The apparatus of claim 16, further comprising instructions being executable by the processor to reduce power to a transmitter when not transmitting the determined number of uplink bursts.

18. The apparatus of claim 16, wherein the instructions to obtain the channel condition metric comprises instructions to receive a downlink burst and measure one of a receive signal power and a signal-to-noise ratio of the downlink burst.

19. The apparatus of claim 16, wherein the channel condition metric is based on an error rate.

20. The apparatus of claim 16, wherein the uplink bursts are transmitted using one of a coding scheme and a modulation and coding scheme based on the channel condition metric.

21. The apparatus of claim 20, wherein the coding scheme and the modulation and coding scheme coding scheme are determined by a lookup table.

22. The apparatus of claim 16, further comprising instructions being executable by the processor to receive a bit error probability indicator, wherein the channel condition metric is based on the bit error probability indicator.

23. The apparatus of claim 22, wherein if the bit error probability indicator is above a threshold, the determined number of uplink bursts are coded with a high efficiency coding scheme.

24. The apparatus of claim 16, further comprising instructions being executable by the processor to receive an uplink report, wherein the channel condition metric is based on the uplink report.

25. The apparatus of claim 16, further comprising instructions being executable by the processor to determine a transmission scheme.

26. The apparatus of claim 25, wherein the transmission scheme varies which uplink burst slots the determined uplink bursts are transmitted at.

27. The apparatus of claim 25, wherein the transmission scheme comprises blanking uplink burst slots in a single radio block that are not transmitted at the non-reduced transmit power level.

28. The apparatus of claim 25, wherein the transmission scheme is based on a battery state of charge.

29. The apparatus of claim 16, wherein the number of uplink bursts transmitted at the non-reduced transmit power level is less than four.

30. The apparatus of claim 16, wherein the uplink bursts are part of a single radio block.

31. A computer-program product for communication on a wireless communication device, the computer-program product comprising a non-transitory computer-readable medium having instructions thereon, the instructions comprising:
code for causing the wireless communication device to obtain a channel condition metric;
code for causing the wireless communication device to determine a number of uplink bursts to be transmitted at a non-reduced transmit power level based on the channel condition metric; and
code for causing the wireless communication device to transmit the determined number of uplink bursts at the non-reduced transmit power level.

32. The computer-program product of claim 31, further comprising code for causing the wireless communication device to reduce power to a transmitter when not transmitting the determined number of uplink bursts.

33. The computer-program product of claim 31, wherein the channel condition metric is based on an error rate.

34. The computer-program product of claim 31, wherein the uplink bursts are transmitted using one of a coding scheme and a modulation and coding scheme based on the channel condition metric.

35. The computer-program product of claim 31, further comprising code for causing the wireless communication device to receive a bit error probability indicator, wherein the channel condition metric is based on the bit error probability indicator.

36. The computer-program product of claim 35, wherein if the bit error probability indicator is above a threshold, the determined number of uplink bursts are coded with a high efficiency coding scheme.

37. The computer-program product of claim 31, further comprising code for causing the wireless communication device to receive an uplink report, wherein the channel condition metric is based on the uplink report.

38. The computer-program product of claim 31, further comprising code for causing the wireless communication device to determine a transmission scheme.

39. The computer-program product of claim 38, wherein the transmission scheme comprises blanking uplink burst slots in a single radio block that are not transmitted at the non-reduced transmit power level.

40. The computer-program product of claim 31, wherein the number of uplink bursts transmitted at the non-reduced transmit power level is less than four.
